(19) United States
(12) Patent Application Publication
(10) Pub. No.: US 2017/0142179 A1
(43) Pub. Date: May 18, 2017

(54) DELIVERY OF MEDIA CONTENT SEGMENTS IN A CONTENT DELIVERY NETWORK

(71) Applicant: Edgeware AB, Stockholm (SE)

(72) Inventor: Goran Appelquist, Ekero (SE)

(21) Appl. No.: 15/194,172

(22) Filed: Jun. 27, 2016

(30) Foreign Application Priority Data
Nov. 16, 2015 (SE) 1551481-3

(51) Int. Cl. H04L 29/06; H04N 21/472; H04N 21/2343; H04L 29/08

(52) U.S. Cl. CPC H04L 65/602; H04L 67/42; H04L 65/4084; H04L 67/02; H04N 21/47202; H04N 21/2343

(57) ABSTRACT

There is provided mechanisms for providing media content segments from a content delivery network. A method is performed by a server of the content delivery network. The method comprises receiving, from a client device and during a client session, a request for a first media content segment from a plurality of first media content segments. The method comprises identifying a third media content segment from a plurality of third media content segments to be provided to the client device in response thereto. The plurality of third media content segments comprises the plurality of first media content segments interleaved with a plurality of second media content segments. The third media content segment is taken from the plurality of second media content segments until an indication that a first set of the plurality of second media content segments has been provided to, and/or played out by, the client device during a sub-session of the client session has been obtained. The third media content segment is otherwise during the sub-session taken from the plurality of first media content segments. The method comprises providing the third media content segment comprising the identified content to the client device.

### RELATED APPLICATION

This application claims priority under 35 CFR section 119(a) to, Swedish Application No. 1551481-3, filed on 16 Nov. 2015, the contents of which are herein incorporated by reference in their entirety for all purposes.

### TECHNICAL FIELD

Embodiments presented herein relate to content delivery networks, and particularly to a method, a server, a computer program, and a computer program product for providing media content segments from a content delivery network.

### BACKGROUND

Dissemination of media programs via the Internet may occur either by downloading, progressive downloading, or streaming.

When streaming is used, media content is delivered continuously to a media player of the client devices and media playback occurs simultaneously as the media content is streamed. The end-user client device is capable of playing the media immediately upon delivery by the content providing web server. Traditional streaming techniques originate from a single provider delivering a stream of data to a set of end-user client devices. Unlike progressive downloading, streaming media can be delivered on-demand or live. Wherein progressive download requires downloading the entire file or downloading enough of the entire file to start playback at the beginning, streaming enables immediate playback at any point within the media file. Some systems allow end-user client devices to skip through the media file to start playback or change playback to any point in the media file. Hence, in such systems the end-user client device does not need to wait for the media file to progressively download. Typically, streaming media is delivered from dedicated servers having high bandwidth capabilities.

Typically, progressively downloaded media files are transmitted to the end-user client devices at a rate that is faster than playback. The media program players at the end-user client devices buffer the data of the media files and may indicate how much of the media file has been buffered by providing an indicator, commonly as a part of a “progress bar.” A control is often provided that allows the end-user of the client devices to go to any point in the program that has already been buffered by selecting the control and moving it to a different location along the progress bar. This allows the user to randomly access any buffered portion of the media program.

Typically, the media files are streamed as a series of discrete “chunks” of media content segments outlined in a manifest file, such as an m3u8 file. The client devices receive the manifest file that contains links to each of the chunks of media content segments, and processes the manifest file to retrieve and play back each chunk in turn.

However, current manifest file formats, such as the m3u8 format, impose several limitations, including the inability to control or guide the conduct of the media player of the client devices. For user requested media content that is accompanied by non-user requested media content, this inability is an impediment to delivering the non-user requested media content, ensuring that the non-user requested media content is not skipped, and/or controlling other aspects of the media consumption experience. The limitations of a manifest file in controlling a media playback device are apparent in other situations as well.

Hence, there is still a need for improved mechanisms for providing media content segments from a content delivery network.

### SUMMARY

An object of embodiments herein is to provide efficient mechanisms for providing media content segments from a content delivery network. According to a first aspect there is presented a method for providing media content segments from a content delivery network. The method is performed by a server of the content delivery network. The method comprises receiving, from a client device and during a client session, a request for a first media content segment from a plurality of first media content segments. The method comprises identifying a third media content segment from a plurality of third media content segments to be provided to the client device in response thereto. The plurality of third media content segments comprises the plurality of first media content segments interleaved with a plurality of second media content segments. The third media content segment is taken from the plurality of second media content segments until an indication that a first set of the plurality of second media content segments has been provided to, and/or played out by, the client device during a sub-session of the client session has been obtained. The third media content segment is otherwise during the sub-session taken from the plurality of first media content segments. The method comprises providing the third media content segment comprising the identified content to the client device.

According to a second aspect there is presented a server for providing media content segments from a content delivery network. The server comprises processing circuitry. The processing circuitry is configured to cause the server to receive, from a client device and during a client session, a request for a first media content segment from a plurality of first media content segments. The processing circuitry is configured to cause the server to identify a third media content segment from a plurality of third media content segments to be provided to the client device in response thereto. The plurality of third media content segments comprises the plurality of first media content segments interleaved with a plurality of second media content segments. The third media content segment is taken from the plurality of second media content segments until an indication that a first set of the plurality of second media content segments has been provided to, and/or played out by, the client device during a sub-session of the client session has been obtained. The third media content segment is otherwise during the sub-session taken from the plurality of first media content segments. The processing circuitry is configured to cause the server to provide the third media content segment comprising the identified content to the client device.

According to a third aspect there is presented a computer program for providing media content segments from a content delivery network. The computer program comprises computer code. When run on processing circuitry of a server, the computer code causes the server to perform a set of operations, or steps. One step involves receiving, from a client device and during a client session, a request for a first media content segment from a plurality of first media content segments. One step involves identifying a third media content segment from a plurality of third media content segments to be provided to the client device in response thereto. The plurality of third media content segments comprises the plurality of first media content segments interleaved with a plurality of second media content segments. The third media content segment is taken from the plurality of second media content segments until an indication that a first set of the plurality of second media content segments has been provided to, and/or played out by, the client device during a sub-session of the client session has been obtained. The third media content segment is otherwise during the sub-session taken from the plurality of first media content segments. One step involves providing the third media content segment comprising the identified content to the client device.

According to a fourth aspect there is presented a computer program product comprising a computer program according to the third aspect and a computer readable storage medium on which the computer program is stored. The computer readable storage medium can be a non-transitory computer readable storage medium.

Advantageously this method, this server, this computer program, and this computer program product provides efficient mechanisms for providing media content segments from a content delivery network.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1a is a schematic diagram illustrating a communication network according to an embodiment;

FIG. 1b is a schematic diagram illustrating part of the communication network of FIG. 1a according to an embodiment;

FIG. 2a is a schematic diagram showing functional units of a server according to an embodiment;

FIG. 2b is a schematic diagram showing functional modules of a server according to an embodiment;

FIG. 3 shows one example of a computer program product comprising computer readable storage medium according to an embodiment;

FIG. 4 is a flowchart of methods according to embodiments;

FIG. 5 schematically illustrates pluralities of different media content segments according to an embodiment;

FIG. 6 schematically illustrates media content segments of a client session according to an embodiment; and

FIG. 7 schematically illustrates manifest files according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

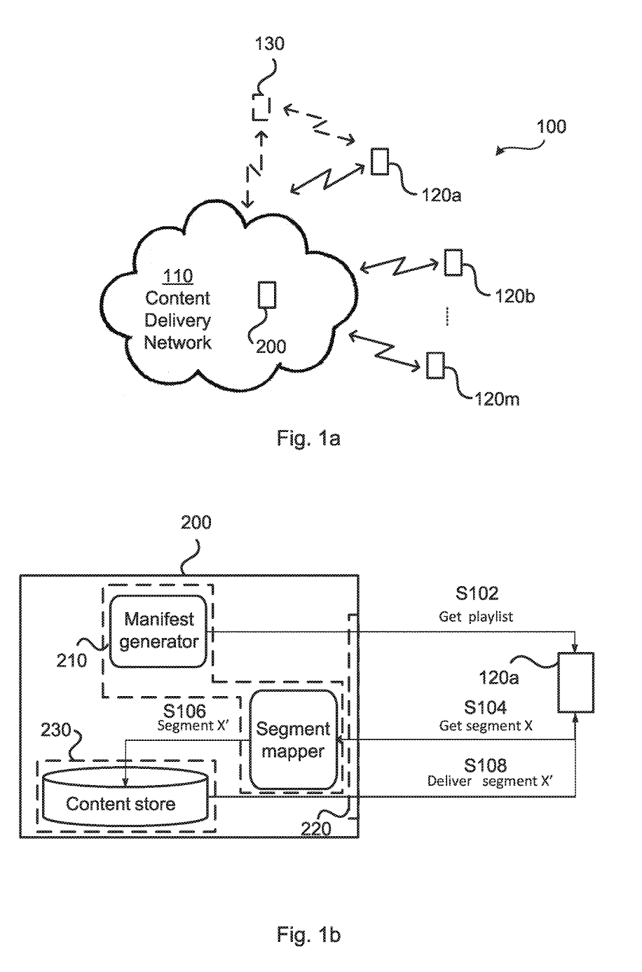

FIG. 1a is a schematic block diagram illustrating a communications network 100 where embodiments presented herein can be applied. The communications network 100 comprises a server 200 and client devices 120a, 120b, . . . , 120m. It is assumed that the server 200 is configured to communicate with the client devices 120a, 120b, . . . , 120m and that the client devices 120a, 120b, . . . , 120m are configured to communicate with the server 200. The communications network 100 may further comprise a control node 130, and when so, the server 200 and the client devices 120a, 120b, . . . , 120m are configured to communicate with the control node 130, and vice versa. The server 200 is provided in a content delivery network 110. As the skilled person understands, although only three client devices 120a, 120b, . . . , 120m are illustrated in FIG. 1a, the herein disclosed embodiments are not limited to any particular number of client devices 120a, 120b, . . . , 120m.

In general terms, the content delivery network 110, also denoted a content distribution network, is a distributed system of proxy servers, as represented by the server 200, deployed in multiple data centers via a wide area network, such as the Internet. One goal of the content delivery network 110 is to serve content, in terms of media content segments, to end-users, in terms of the client devices 120a, 120b, . . . , 120m, with high availability and high performance. According to the embodiments disclosed herein, the content delivery network 110 is assumed to provide content in terms of media files such as live streaming media and on-demand streaming media.

FIG. 1b is a schematic block diagram illustrating a wireless device 120 and a server 200 as part of the communications network 100 of FIG. 1a. The server 200 of FIG. 1b comprises processing circuitry 210 implementing a manifest generator and a segment mapper. The server 200 further comprises a communications interface 220 for communicating with the wireless device 120a. The server 200 further comprises a storage medium 230 comprising a content store. Operations, or steps, associated with the inventive concept as herein disclosed are identified at S102, S104, S106, and S108. The functionalities of the manifest generator, the segment mapper, and the content store, as well as steps S102, S104, S106, and S108, will be further disclosed below.

As disclosed above, the media files are typically streamed as a series of discrete “chunks” of media content segments outlined in a manifest file. For reasons disclosed above, current manifest file formats are not suitable for user requested media content that is accompanied by non-user requested media content.

The embodiments disclosed herein therefore relate to providing media content segments from a content delivery network 110. In order to obtain such providing there is provided a server 200, a method performed by the server 200, and a computer program product comprising code, for example in the form of a computer program, that when run on a server 200, causes the server 200 to perform the method.

Reference is now made to FIG. 4 illustrating a method for providing media content segments from a content delivery network 110 as performed by the server 200 according to embodiments. The methods are advantageously provided as computer programs 320 (see description of FIG. 3 below). Parallel reference is made to FIGS. 1a and 1b.

The server 200 is configured to, in a step S104, receive a request for a first media content segment 511i from a plurality of first media content segments 510. In FIG. 1b this is illustrated by the message “Get segment X” being sent by the client device 120a to the server 200.

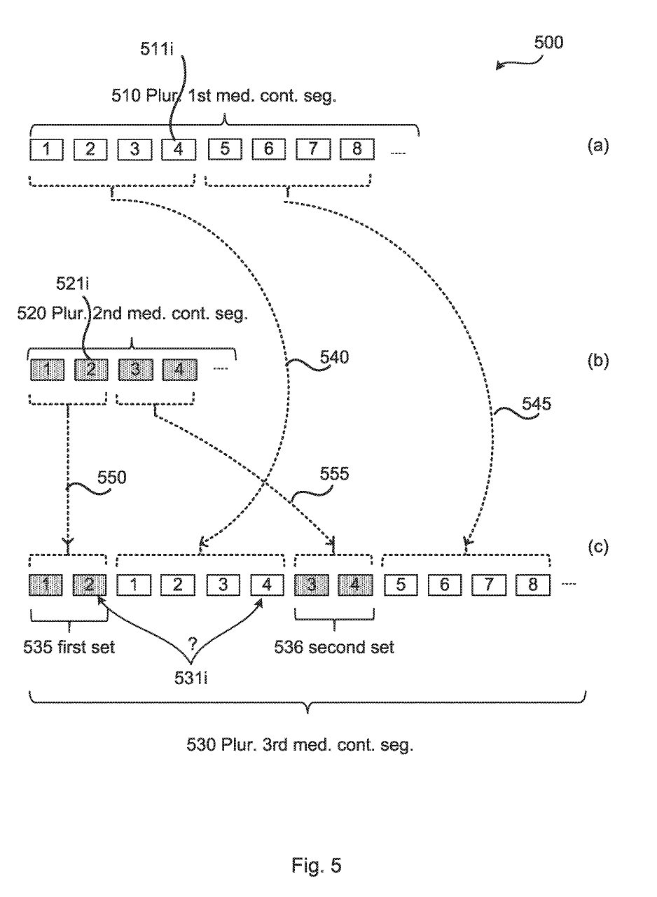

Reference is here also made to FIG. 5. FIG. 5 at reference numeral 500 schematically illustrates a plurality of different media content segments. At (a) is illustrated a plurality of first media content segments 510, where one of the first media content segments is denoted 511i. At (b) is illustrated a plurality of second media content segments 520, where one of the second media content segments is denoted 521i. At (c) is illustrated a plurality of third media content segments 530, where one of the third media content segments is denoted 531i.

The request in step S104 is received from one of the client devices 120a, 120b, . . . , 120m, hereinafter denoted client device 120a. Further, the request in step S104 is received during a client session 610. In this respect, the request received in step S104 may be received any time during the client session 610; the request could be received during the beginning of the client session, during the middle of the client session, or at the end of the client session.

As can be seen in the illustrative example of FIG. 5, the plurality of third media content segments 530 alternatingly comprises sets of media content segments taken from the plurality of first media content segments 510 (as indicated by arrows 540, 545) and media content segments taken from the plurality of second media content segments 520 (as indicated by arrows 550, 555). Hence, the plurality of third media content segments 530 comprises the plurality of first media content segments 510 interleaved with the plurality of second media content segments 520. In this respect, the plurality of third media content segments 530 comprises a first set 535 of media content segments taken from the plurality of second media content segments 520 and a second set 536 of media content segments taken from the plurality of second media content segments 520.

The server 200 is configured to, in a step S106, identify a third media content segment 531i from the plurality of third media content segments 530 to be provided to the client device 120a in response thereto (i.e., in response to the request received in step S104). In FIG. 1b this is illustrated by “Segment X′” being identified in the content store 230.

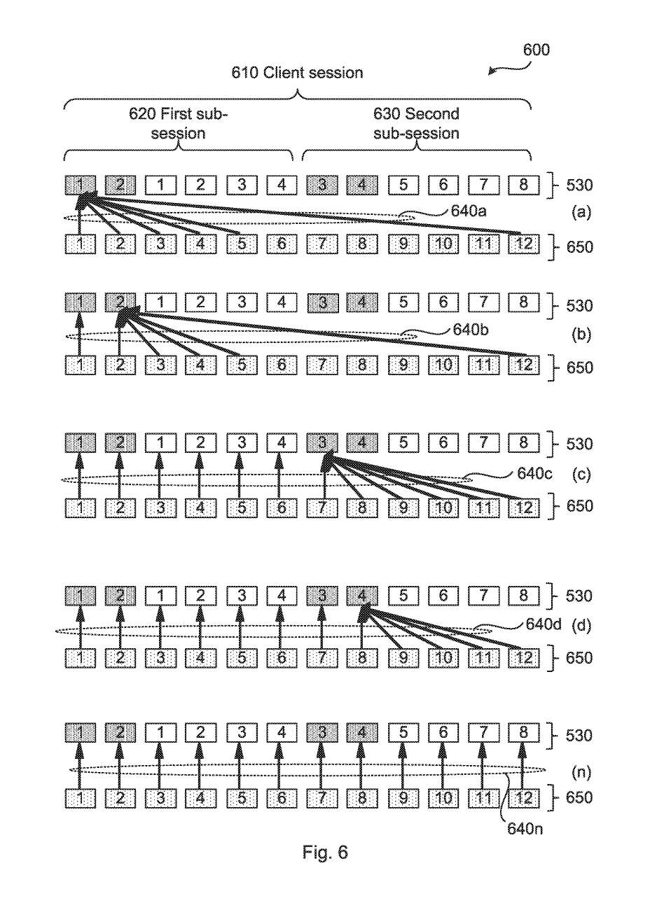

As schematically illustrated by the question mark “?” in the illustrative example of FIG. 5, the third media content segment 531i could, in the plurality of third media content segments 530, be taken either from the plurality of first media content segments 510 or from the plurality of second media content segments 520. Particularly, the third media content segment 531i is taken from the plurality of second media content segments 520 until an indication that the first set 535 of the plurality of second media content segments 520 has been provided to, and/or played out by, the client device 1120a during a sub-session 620 of the client session 600 has been obtained (see, FIG. 6). The third media content segment 531i is otherwise during the sub-session 620 taken from the plurality of first media content segments 510. In this respect, with reference to FIG. 1b, X′≠X until an indication that the first set 535 of the plurality of second media content segments 520 has been provided to, and/or played out by, the client device 1120a during a sub-session 620 of the client session 600 has been obtained, and X′=X otherwise.

In this respect it may thus not only been necessary that the first set 535 of the plurality of second media content segments 520 has been provided to the client device 120a during the sub-session 620 of the client session 600, but also that the first set 535 of the plurality of second media content segments 520 actually has been played out by the client device 120a during the sub-session 620 of the client session 600. Examples of how the indication can be obtained by the server 200 will be provided below.

The server 200 is further configured to, in a step S108, provide the third media content segment 531i comprising the identified content to the client device 120a. In FIG. 1b this is illustrated by “Deliver segment X′”, where “Segment X′” is delivered from the content store 230 of the server 200 to the client device 120a.

Embodiments relating to further details of providing media content segments from a content delivery network 110 will now be disclosed.

There may be different ways for the server 200 to receive the request for the first media content segment 511i from the client device 120a, as in step S104. For example, the communications between the server 200 and the client devices 120a, 120b, . . . , 120m may be based on the Hypertext Transfer Protocol (HTTP). Thus, the request for the first media content segment 511i can be received in a HTTP request.

Further, there may be different ways for the server 200 to provide the third media content segment 531i to the client device 120a, as in step S108. For example, if the communications between the server 200 and the client devices 120a, 120b, . . . , 120m is be based on HTTP, the third media content segment 531i can be provided using Dynamic Adaptive Streaming over HTTP (known as DASH or MPEG-DASH, where MPEG is short for Moving Picture Experts Group).

In general terms, DASH is an adaptive bitrate streaming technique that enables high quality streaming of media content over the Internet delivered from the server 200, where the server 200 in this respect can act as a conventional HTTP web server. Similar to HTTP Live Streaming (HLS), MPEG-DASH works by breaking the media content into a sequence of small HTTP-based file segments, as herein represented by the media content segments 511i, 521i, 531i, each media content segment 511i, 521i, 531i comprising a short interval of playback time of media content that is potentially many hours in duration, such as a movie or the live broadcast of a sports event (see above).

There may be different points in time (relative the first occurring media content segment that is provided to the client device 120a) when the request for the first media content segment 511i is received from the client device 120a (as in step S104). Reference is here made to FIG. 6 which at reference numeral 6000 schematically illustrates media content segments of a client session 610 according to an embodiment. The client session 610 comprises a first sub-session 620 and a second sub-session 630.

FIG. 6 further illustrates a dynamic re-mapping at 640a, 640b, 640c, 640d, 640n between the plurality of third media content segment 530 and media content segments 650 of a client playlist.

At (a) it is assumed that none of the plurality of third media content segment 530 have been provided to, or played out by, the client device 120a, and all media content segments 650 of the client playlist thus point to the first occurring media content segment of the plurality of third media content segment 530 (which, according to FIGS. 5(a)-(c) is the first occurring of the plurality of second media content segment 520).

At (b) it is assumed that the first occurring media content segment (which, according to FIGS. 5(a)-(c) is the first occurring second media content segment of the plurality of second media content segment 520) of the plurality of third media content segment 530 has been provided to, or played out by, the client device 120a, and all media content segments 650 of the client playlist thus point to the second occurring media content segment of the plurality of third media content segment 530 (which, according to FIGS. 5(a)-(c) is the second occurring second media content segment of the plurality of second media content segment 520).

At (c) it is further assumed that all media content segment of the first set 535 of the plurality of third media content segment 530 (which, according to FIGS. 5(a)-(c) are the first two occurring second media content segments of the plurality of second media content segment 520) have been provided to, or played out by, the client device 120a, and all media content segments 650 of the client playlist occurring before the second set 536 of the plurality of third media content segment 530 (which, according to FIGS. 5(a)-(c) are the last two occurring second media content segments of the plurality of second media content segment 520) thus point to a corresponding occurring media content segment of the plurality of third media content segment 530, whilst all media content segments 650 of the client playlist occurring thereafter point to a first occurring media content segment of the second set 536 of the plurality of third media content segment 530.

At (d) it is further assumed that also a first occurring media content segment of the second set 536 of the plurality of third media content segment 530 has been provided to, or played out by, the client device 120a, and all media content segments 650 of the client playlist occurring thereafter thus point to the second occurring media content segment of the second set 536 of the plurality of third media content segment 530.

At (n) it is further assumed that all media content segment of the first set 535 and the second set 536 of the plurality of third media content segment 530 have been provided to, or played out by, the client device 120a, and all media content segments 650 of the client playlist thus point to a corresponding occurring media content segment of the plurality of third media content segment 530.

For example, the request for the first media content segment 511i can, in step S104, be received during the sub-session during which the first set 535 of the plurality of second media content segments 520 is to be provided to, and/or played out by, the client device 120a. In FIG. 6 this sub-session is the first sub-session 620; see, especially FIG. 6(a)-(b)). Alternatively, the request for the first media content segment 511i can, in step S104, be received during a subsequent sub-session of the client session 610. In FIG. 6 this sub-session is the second sub-session 630. In this case, all second media content segments 520 of the first sub-session 620 have been played out by, or at least delivered to, the client device 120a (e.g., after the first set 535 of the plurality of second media content segments 520 has been provided to the client device 120a during the first sub-session 620; see, FIG. 6(c)-(d)). The third media content segment 531i can thus be taken from the plurality of second media content segments 520 until a second set 536 of the plurality of second media content segments 520 has been provided to the client device 120a during the subsequent sub-session 630 of the client session 610. The third media content segment 531i is otherwise, during the subsequent sub-session 630, taken from the plurality of first media content segments 510; see, FIG. 6(n).

There may be different ways to perform the identification of the third media content segment 531i according to the conditions provided above in relation to step S106. For example, the third media content segment 531i can be identified according to the dynamic re-mapping function 640a, 640b, . . . , 640n. The plurality of first media content segments 510 and the plurality of second media content segments 520 can thereby be associated with the plurality of third media content segments 530 via the dynamic re-mapping function 640a, 640b, . . . , 640n. The dynamic re-mapping function 640a, 640b, . . . , 640n can be implemented by the segment mapper in FIG. 1b. The third media content segment 531i can then, according to the dynamic re-mapping function 640a, 640b, . . . , 640n, be identified using a dynamic re-mapping between the plurality of first media content segments 510 and the plurality of third media content segments 530. As disclosed above, the dynamic re-mapping function 640a, 640b, . . . , 640n can be updated according to any third media content segments 531i already having been provided to the client device 120a during the client session 610.

The content can be made available at a variety of different bit rates, i.e., alternative media content segments 511i, 521i, 531i can be encoded at different bit rates covering aligned short intervals of play back time are made available.

Hence, according to an embodiment, each of the plurality of first media content segments 510, the plurality of second media content segments 520, and the plurality of third media content segments 530 are provided at at least two bit rates. Information of the at least two bit rates of the plurality of at least the first media content segments can be provided in a manifest file accessible by the client devices 120a, 120b, . . . , 120m.

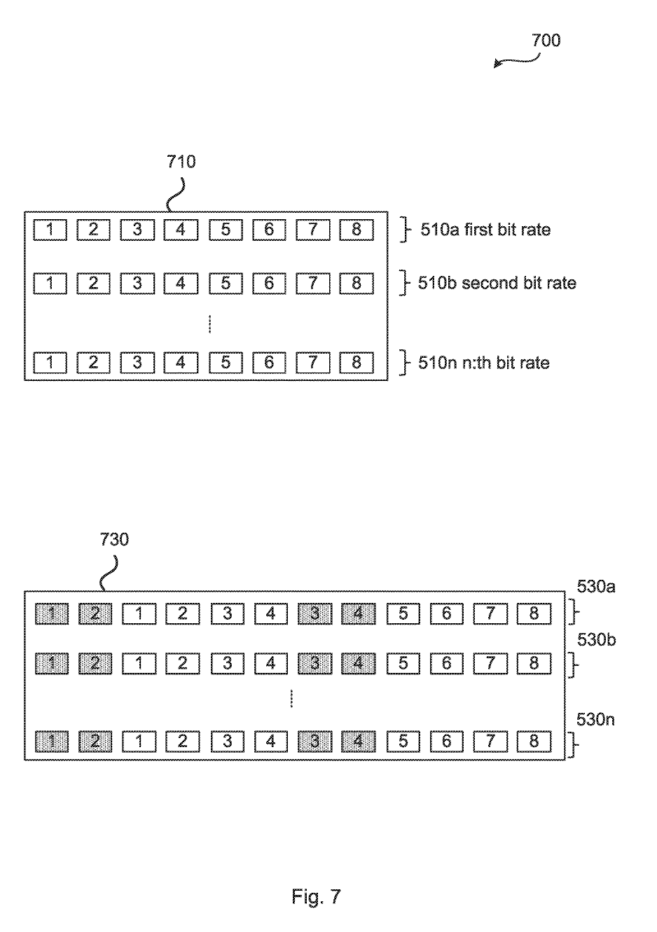

FIG. 7 at reference numeral 700a schematically illustrates manifest files 710, 730 according to an embodiment. The manifest files 710 comprises a plurality of first media content segments 510a, 500b, 510n at a first bitrate, a second bitrate and an n:th bitrate, respectively. The manifest files 730 comprises a plurality of third media content segments 530a, 530b, 530n at a first bitrate, a second bitrate and an n:th bitrate, respectively. The manifest files 710, 730 can be generated by the manifest generator 210, see FIG. 1b.

The request for the first media content segment 511i (as in step S104) may then further comprise identification of at least one of the at least two bit rates. The third media content segment 531i may then by the server 200 be provided to the client device 120a at this at least one of the at least two bit rates (as in step S108).

While the content is being played back by the client device 120a, 120b, . . . , 120m, the client device 120a, 120b, . . . , 1200m automatically selects from the alternatives the next media content segment to download and play back based on current network conditions. The client device 120a, 120b, . . . , 1200m can, for example, select the segment with the highest bit rate possible that can be downloaded in time for play back without causing stalls or re-buffering events in the playback. Thus, the client device 120a, 120b, . . . , 120m can seamlessly adapt to changing network conditions, and provide high quality play back with few stalls or re-buffering events.

However, also other ways for the server 200 to provide the third media content segment 531i to the client device 120a are possible and the inventive concept as presented herein is not limited to the use of DASH or any other mechanism where each of the plurality of first media content segments 510, the plurality of second media content segments 520, and the plurality of third media content segments 530 are provided at at least two bit rates.

As disclosed above, the client device 120a can request the server 200 to deliver media content to the client device 120a. The server can respond to this request by providing a manifest file in order for the client device 120a to obtain information that can be used by an end-user of the client device 120a to select which media content segment to request (i.e., which first media content segment 511i from the plurality of first media content segments 510 to request). Therefore, the first media content segment 511i can be associated with the plurality of first media content segments 510 via the manifest file 730. Further, the second media content segment 521i can be associated with the plurality of second media content segments 520 via the same manifest file 730.

The server 200 may therefore be configured to, in a step S102, provide the manifest file 730 to the client device 120a prior to receiving the request in step S104. In FIG. 1b this is illustrated by the message “Get playlist” being communicated between the client device 120a and the server 200.

Examples of how the indication that the first set 535 of the plurality of second media content segments 520 has been provided to, and/or played out by, the client device 120a during the sub-session 620 of the client session will now be provided.

For example, the indication can be received from the client device 120a. That is, according to an embodiment the indication that the first set 535 of the plurality of second media content segments 520 has been provided to, and/or played out by, the client device 120a during the sub-session 620 of the client session 610 is obtained from the client device 120a. Alternatively, the indication can be received from a control node 130. Hence, according to an embodiment the indication that the first set 535 of the plurality of second media content segments 520 has been provided to, and/or played out by, the client device during 120a the sub-session 620 of the client session 610 is obtained from a control node 130. The latter could represent a scenario where the multimedia player of the client device 120a reports to the central node what media content segments have been played out by the multimedia player. The control node 130 could then, when having received an indication from the client device 120a that the first set 535 of the plurality of second media content segments 520 has been provided to, and/or played out by, the client device 120a during the sub-session 620 of the client session 610, forward this information to the server 200.

There may be different types of first media content segments 510. For example, the plurality of first media content segments 510 can represent user requested media content. There may be different types of content in the first media content segments 510. For example, the plurality of first media content segments 510 can represent an on-demand media file. The on-demand media file may be an encoded video file. Hence the server 200 may be part of a video on demand (VOD) system. VOD generally refers to a system which allows users of the client devices 120a, 120b, . . . , 120m to select and watch/listen to video or audio content when they choose to, rather than having to watch at a specific broadcast time. Additionally or alternatively, the plurality of first media content segments 510 can represent an encoded live stream media file. Hence the server 200 may be part of a live streaming system. Live streaming could represent delivering the live stream media file live over the Internet and generally requires a form of source media (e.g. a video camera, an audio interface, screen capture software), an encoder to digitize the content, a media publisher, and a content delivery network 110 to distribute and deliver the content to the client device 120a.

There may be different types of second media content segments 520. For example, the plurality of second media content segments 520 can represent non-user requested media content. In view of the above, the plurality of second media content segments 520 can thus represent media content that users of the client devices 120a, 120b, . . . , 120m have not selected to received, but which is anyway delivered to client devices 120a, 120b, . . . , 120m according to the conditions given in relation to step S106 above. According to a non-limiting example, the second media content segments 520 comprise advertisement content.

According to a embodiment all media content segments (i.e., all first media content segment 510, all second media content segment 520, and all third media content segment 530) are of the same length.

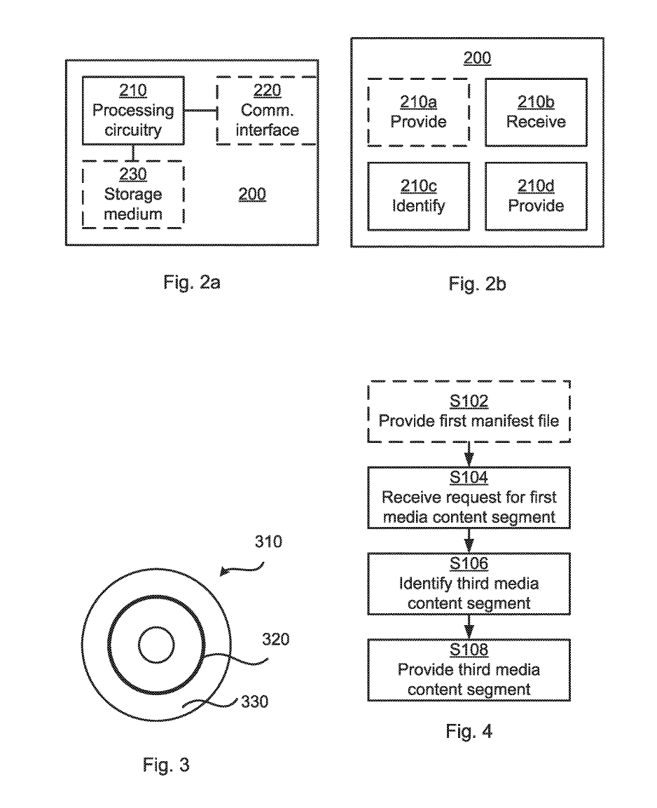

FIG. 2a schematically illustrates, in terms of a number of functional units, the components of a server 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 310 (as in FIG. 3), e.g. in the form of a storage medium 230. The processing circuitry 210 may further be provided as at least one application specific integrated circuit (ASIC), or field programmable gate array (FPGA).

Particularly, the processing circuitry 210 is configured to cause the server 200 to perform a set of operations, or steps, S102-S108. These operations, or steps, have been disclosed above. For example, the storage medium 230 may store the set of operations, and the processing circuitry 210 may be configured to retrieve the set of operations from the storage medium 230 to cause the server 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The server 200 may further comprise a communications interface 220 for communications with at least one client device 120a, 120b, . . . , 120m. As such the communications interface 220 may comprise one or more transmitters and receivers, comprising analogue and digital components and. The processing circuitry 210 controls the general operation of the server 200 e.g. by sending data and control signals to the communications interface 220 and the storage medium 230, by receiving data and reports from the communications interface 220, and by retrieving data and instructions from the storage medium 230. Other components, as well as the related functionality, of the server 200 are omitted in order not to obscure the concepts presented herein.

FIG. 2b schematically illustrates, in terms of a number of functional modules, the components of a server 200 according to an embodiment. The server 200 of FIG. 2b comprises a number of functional modules; a receive module 210b configured to perform step S104, an identify module 210c configured to perform step S106, and a provide module 210d configured to perform step S108. The server 200 of FIG. 2b may further comprises a number of optional functional modules, such as a provide module 210a configured to perform step S102. In general terms, each functional module 210a-210d may in one embodiment be implemented only in hardware or and in another embodiment with the help of software, i.e., the latter embodiment having computer program instructions stored on the storage medium 230 which when run on the processing circuitry makes the server 200 perform the corresponding steps mentioned above in conjunction with FIG. 2b. It should also be mentioned that even though the modules correspond to parts of a computer program, they do not need to be separate modules therein, but the way in which they are implemented in software is dependent on the programming language used. Preferably, one or more or all functional modules 210a-210d may be implemented by the processing circuitry 210, possibly in cooperation with functional units 220 and/or 230. The processing circuitry 210 may thus be configured to from the storage medium 230 fetch instructions as provided by a functional module 210a-210d and to execute these instructions, thereby performing any steps as disclosed herein.

FIG. 3 shows one example of a computer program product 310 comprising computer readable storage medium 330. On this computer readable storage medium 330, a computer program 320 can be stored, which computer program 320 can cause the processing circuitry 210 and thereto operatively coupled entities and devices, such as the communications interface 220 and the storage medium 230, to execute methods, as defined by steps S102-S108, according to embodiments described herein. The computer program 320 and/or computer program product 310 may thus provide means for performing any steps as herein disclosed.

In the example of FIG. 3, the computer program product 310 is illustrated as an optical disc, such as a CD (compact disc) or a DVD (digital versatile disc) or a Blu-Ray disc. The computer program product 310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 310.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for providing media content segments from a content delivery network, the method being performed by a server of the content delivery network, the method comprising:
receiving, from a client device and during a client session, a request for a first media content segment from a plurality of first media content segments;
identifying a third media content segment from a plurality of third media content segments to be provided to the client device in response thereto,
wherein the plurality of third media content segments comprises the plurality of first media content segments interleaved with a plurality of second media content segments,
wherein the third media content segment is taken from the plurality of second media content segments until an indication that a first set of the plurality of second media content segments has been provided to, and/or played out by, the client device during a sub-session of the client session has been obtained, and the third media content segment otherwise during the sub-session is taken from the plurality of first media content segments; and
providing the third media content segment comprising the identified content to the client device.

2. The method according to claim 1, wherein all media content segments are of same length.

3. The method according to claim 1, wherein the request for the first media content segment is received during the sub-session.

4. The method according to claim 1, wherein the request for the first media content segment is received during a subsequent sub-session of the client session.

5. The method according to claim 4, wherein the third media content segment is taken from the plurality of second media content segments until a second set of the plurality of second media content segments has been provided to the client device during the subsequent sub-session of the client session, and the third media content segment otherwise during the subsequent sub-session is taken from the plurality of first media content segments.

6. The method according to claim 1, wherein the first media content segment is associated with the plurality of first media content segments via a manifest file, and wherein the second media content segment is associated with the plurality of second media content segments via the same manifest file.

7. The method according to claim 6, further comprising:
providing the manifest file to the client device prior to receiving the request.

8. The method according to claim 1, wherein the third media content segment is identified according to a dynamic re-mapping function.

9. The method according to claim 8, wherein the plurality of first media content segments and the plurality of second media content segments are associated with the plurality of third media content segments via the dynamic re-mapping function.

10. The method according to claim 8, wherein the third media content segment is according to the dynamic re-mapping function identified using a dynamic re-mapping between the plurality of first media content segments and the plurality of third media content segments.

11. The method according to claim 8, wherein the dynamic re-mapping function is updated according to third media content segments already having been provided to the client device during the client session.

12. The method according to claim 1, wherein each of the plurality of first media content segments, the plurality of second media content segments, and the plurality of third media content segments are provided at at least two bit rates.

13. The method according to claims 6 and 12, or 7 and 12, wherein the manifest file further comprises information of the at least two bit rates of the plurality of first media content segments.

14. The method according to claim 13, wherein the request for the first media content segment further comprises identification of at least one of the at least two bit rates, and wherein the third media content segment is provided at the at least one of the at least two bit rates to the client device.

15. The method according to claim 1, wherein the indication that the first set of the plurality of second media content segments has been provided to, and/or played out by, the client device during the sub-session of the client session is obtained from the client device.

16. The method according to claim 1, wherein the indication that the first set of the plurality of second media content segments has been provided to, and/or played out by, the client device during the sub-session of the client session is obtained from a control node.

17. The method according to claim 1, wherein the plurality of first media content segments represents user requested media content.

18. The method according to claim 1, wherein the plurality of second media content segments represents non-user requested media content.

19. The method according to claim 1, wherein the plurality of first media content segments represents an on-demand media file.

20. The method according to claim 1, wherein the plurality of first media content segments represents a live stream media file.

21. The method according to claim 1, wherein the request for the first media content segment is received in a Hypertext Transfer Protocol, HTTP, request.

22. The method according to claim 21, wherein the third media content segment is provided using Dynamic Adaptive Streaming over HTTP, DASH.

23. A server for providing media content segments from a content delivery network, the server comprising processing circuitry, the processing circuitry being configured to cause the server to:
receive, from a client device and during a client session, a request for a first media content segment from a plurality of first media content segments;
identify a third media content segment from a plurality of third media content segments to be provided to the client device in response thereto,
wherein the plurality of third media content segments comprises the plurality of first media content segments interleaved with a plurality of second media content segments,
wherein the third media content segment is taken from the plurality of second media content segments until an indication that a first set of the plurality of second media content segments has been provided to, and/or played out by, the client device during a sub-session of the client session has been obtained, and the third media content segment otherwise during the sub-session is taken from the plurality of first media content segments; and
provide the third media content segment comprising the identified content to the client device.

24. A computer program product for providing media content segments from a content delivery network, and a non-transitory computer readable storage medium on which the computer program is stored, the computer program comprising computer code which, when run on processing circuitry of a server, causes the server to:
receive, from a client device and during a client session, a request for a first media content segment from a plurality of first media content segments;
identify a third media content segment from a plurality of third media content segments to be provided to the client device in response thereto,
wherein the plurality of third media content segments comprises the plurality of first media content segments interleaved with a plurality of second media content segments,
wherein the third media content segment is taken from the plurality of second media content segments until an indication that a first set of the plurality of second media content segments has been provided to, and/or played out by, the client device during a sub-session of the client session has been obtained, and the third media content segment otherwise during the sub-session is taken from the plurality of first media content segments; and
provide the third media content segment comprising the identified content to the client device.
